(19) United States
(12) Patent Application Publication
(10) Pub. No.: US 2008/0255998 A1
(43) Pub. Date: Oct. 16, 2008

(54) Construction Asset Backed Securities Method With Pud Auction Through Internet

(76) Inventor: Younshig Ju, Kimhae-Si (KR)

Correspondence Address: IPLA P.A., 3580 WILSHIRE BLVD., 17TH FLOOR, LOS ANGELES, CA, 90010, US

(21) Appl. No.: 12/091,001

(22) PCT Filed: Oct. 18, 2006
(86) PCT No.: PCT/KR2006/004226

§ 371 Date: Apr. 21, 2008

(30) Foreign Application Priority Data
Oct. 19, 2005 (KR) 10-2005-0099432

(51) Int. Cl. G06Q 99/00

(52) U.S. Cl. 705/80

(57) ABSTRACT

The present invention is relating to the construction asset backed securities method through Internet, wherein above the method comprising the following steps: —registering developers, enterprises (Special Purpose Company; SPC) and financial institutions accessed to the PUD auction server as main bodies for development project; —proposing the project land for auction received the consents of enrolled landowners within the subject districts, after determining the project boundary with the Optimal Zoning Program in GIS fold of the Geography and Image server (S2) based on the overall data for a group of enrolled lands which are input by registered developer; —registering multiple alternative plans approvable to project as the alternative plans for each PUD land of DB server, the above multiple alternative plans are established for the PUD lands which are taken a procedure for determining the specific development district through the Alternative Planning Platform of PUD development folder; —determining the best alternative plans for each PUD through the successful bidding, the above bidding is determined by evaluating the points of bidding prices in addition to the points for appeasing monopoly and the points of performance capability of construction through the Successful Bidder Determining Program after receiving the biddings of enterprises about the multiple alternative plans registered for each PUD land through the bidding program of auction folder in the web server (S1); and—circulating the real-right on development securities as construction assets, the above development securities are issued in connection with the financial institutions with certain rate of constructing floor area ratio approved by authorized office under the development plans.

### TECHNICAL FIELD

The present invention relates to a construction asset backed securities method that the project lands to be a basis for development projects site are traded with a bidding type auction through on-line after making development plans, and the indirect-investing construction assets of general investors can be supplied by issuing the real-right on development securities within a certain range of the project-approved floor area ratio.

### BACKGROUND ART

Conventionally, construction companies often tried to purchase each land with real business purpose concealed when procuring project lands through off-line. With this prior off-line method of construction companies, however, it takes a considerable long time to procure the required project lands to begin the relevant project. Thus, the landowner who already sold his or her own lands at an early stage would get a great loss, feel a comparative deprivation due to the rising land price, and could not receive the proper development profits. Furthermore, the prior off-line method has many problems in proceeding the planned project, since the neighboring landowner who witnessed the land price soaring situations would reject selling his or her own land and a variety of public petitions are issued.

In addition, it is a conventional practice of the prior off-line method that the construction asset loan is mainly provided based on the collateral (e.g. land) and the construction company s guarantee for completion, not the project feasibility or the credit evaluation of enterprise (Special Purpose Company; SPC). With this conventional practice, it is difficult to provide the construction money in proper time since there is a limit and stringency for the supplying asset and asset supplying organization. Consequently, it leads to the corporation bankruptcy and faulty construction work.

### DISCLOSURE OF INVENTION

### Technical Problem

The present invention is to solve the above problems of the prior off-line method.

### Technical Solution

The object of present invention is to provide a construction asset backed securities method with PUD auction through Internet, that can simultaneously obtain the project land through Internet for which the planned developments are possible in the group of lands, reduce the cost in purchasing project land by making landowners receive a considerable development profit within the limits of supplied lands for a planned development rather than individual land trade and become strong supporter for the smooth project completion, shorten the project period for development by using the present PUD auction method, and timely supply abundant construction assets to sound small companies by solving the problems in conventional construction industry caused by big companies' monopoly to construction asset.

Accordingly, the object of present invention is to provide the auction method for project land (PUD) of a group of lands to be developed in a planned manner in order to overcome difficulties of enterprises who wish to acquire lands, and induce a immense floating money, which does not find out pertinent investment destination and speculates on real estates, into the stable construction asset by making financial institutions issue the real-right on development securities within the confirmed floor area ratio of approved project in order for enterprises whose biddings are accepted to be easily supplied the initial construction asset in proceeding construction projects.

### ADVANTAGEOUS EFFECTS

As will be discussed in below, the construction asset backed securities method according to the present invention has effects that can make a planned development by trading the project land (Planned Unit Development; PUD) for development with a bidding type auction, procure a group of project lands in a short time from landowners who are guaranteed a considerable development profit, reduce numerous public petitions caused by the difference in compensation money due to the time difference in purchasing lands, solve the problems of conventional collateral-based loan, which can make the asset management of enterprises more difficult, with the aid of abundant project financing to overcome the shortage of construction money, which can occur in the early period of development due to the construction industry inherent features whose construction assets revenues are concentrated on completion stage. Furthermore, the present method can induce the huge amount of floating money used in speculating to real estate into the stable real estate development with indirect investment form.

### BRIEF DESCRIPTION OF THE DRAWINGS

FIG. 1 is a system diagram for the project land auction system in accordance with the present invention.

FIG. 2 shows that the interested parties interchange information with each other with the project auction system of the present invention, in order to proceed development project.

FIG. 3 is a flowchart according to the present invention illustrating all steps from determining development district and issuing the development securities to completing construction project.

### BEST MODE FOR CARRYING OUT THE INVENTION

In order to achieve these and other advantages and objects in accordance with the present invention, the construction asset backed securities method through Internet according to the present invention is characterized by the method comprising the following steps:
registering developers, enterprises (Special Purpose Company; SPC) and financial institutions accessed to PUD auction server as main bodies for development project;
proposing the project land for auction received the consents of enrolled landowners within the subject districts, after determining the project boundary with the Optimal Zoning Program in GIS fold of the Geography and Image server (S2) based on the overall data for a group of enrolled lands which are input by registered developer;
registering multiple alternative plans approvable to project as the development proposals for each PUD land of DB server, the above multiple alternative plans are established for the PUD lands which are taken a procedure for determining the specific development district through the Alternative Planning Platform of PUD development folder;
determining the best development plan for each PUD land through the successful bidding, the above bidding is determined by evaluating the points of bidding prices in addition to the points for appeasing monopoly and the points of performance capability of construction through the Successful Bidder Determining Program after receiving the biddings of enterprises about the multiple alternative plans registered for each PUD land through the Bidding Program of auction folder in the web server (S1); and
circulating the real-right on development securities as construction assets, the above development securities are issued in connection with the financial institutions with certain rate of completing floor area ratio approved by authorized office under the best development plan.

### MODE FOR THE INVENTION

The embodiments of present invention will be described in a detailed manner, by way of example only, with reference to the accompanying drawings.

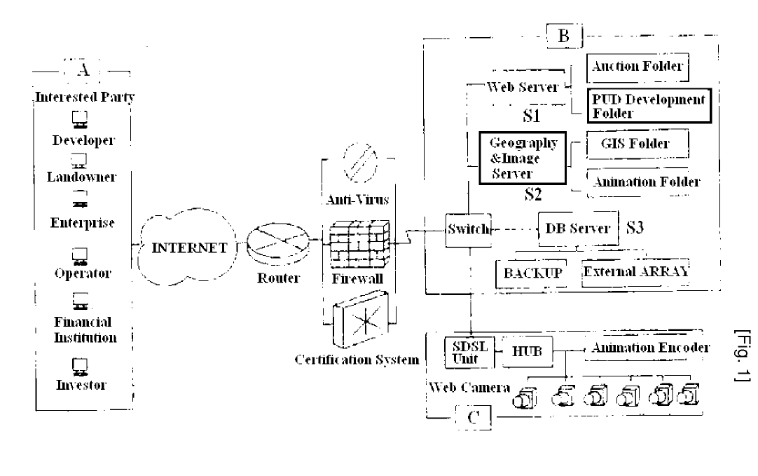

FIG. 1 is a system diagram for the project land auction system according to the present invention. As shown in the drawing, the project land auction system (PUD auction system) through Internet comprises input/output section (A), PUD auction server (B), Internet, and animation encoder hub (C). The above components are organically connected and operated. The above input/output section (A) consists of the interested party, the developers who investigate project lands and propose PUD site, the enterprises (Special Purpose Company; SPC) who proceed construction project, the financial institutions who issue development securities, landowners, investors and the PUD auction operator. The above PUD auction server (B) has a web server (S1), a Geography and Image server (S2) and a DB server (S3). The above animation encoder hub (C) supplies the animated verification data of project site.

The web server (S1) is comprised of the auction folder for PUD auction procedure and the PUD development folder for planning and registering PUD development proposals. The above PUD development folder can divide processing works with the security account file, the proposal maker registration file, the Alternative Planning Platform file and development proposal registration file for each project land.

The Geography and Image server (S2) is comprised of the GIS folder and the animation folder. The above GIS folder divides processing works with the proposal (developer) management file, the Project Land Proposal Platform inputting and proposing the information for geography and features about subject lands of development, the Optimal Zoning Program file that analyzes available land and determines developing area by analyzing geographical information, and the project land management file. In addition, the animation folder assists to understand the geographical analysis for subject land and check the progress of construction with real-time by providing animation files for the construction sites.

The DB server (S3) records registration information for developers, enterprises and financial institutions who are main parts of the present invention, and provides all relevant data and information in each step for real-time access of authorized persons to observe and manage the clear information for successful proceeding of all development projects which are constructed by PUD auction. The above all clear information can include the PUD lands for auction, a number of alternative plans for each project land, the bidding result of auctions, the approval results of alternative plans, the record of issuing the real-right on development securities, the animation data for PUD construction site and the management records for payment about completed parts of development project construction site.

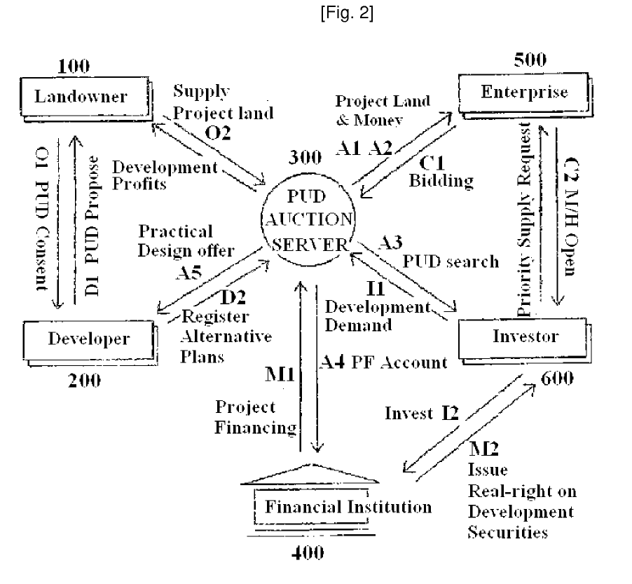

FIG. 2 illustrates that the interested parties interchange information with each other in order to promote development project by using the project land auction system of the invention. FIG. 2 also shows the network system to exchange information based on the PUD auction server (300) by the concerned parties and institutions participating in the auction for development proposal project lands and the construction asset backed securities through on-line.

As shown in FIG. 2, the developers (200) provisionally determine the district to be developed, get the incorporation consents from landowners (100), input and propose into the PUD auction server (300) about information including the geographic & land use information for location, type, area, ownership, classification of land along with the land use inventories for each parcel to be incorporated as project lands. Then, the developers, engineers and architects design creative proposals for specific development district, set up and register the feasible development proposal by the Alternative Planning Platform located in the PUD development folder of web server (S1). The above feasible development plans will be registered into the DB server as the alternative plans for each PUD land for PUD auction, after being analyzed about the integrity, creativity and validity for the project plan.

When a number of alternative plans are registered, the PUD auction server (300) will inform the already registered enterprises (500) of the bidding notification and registration situation for each PUD of project land, and enter into the auction procedures. When the enterprises candidates who wish to acquire the specific PUD of the auction bidding notification apply and succeed in the bidding, it will be the best development plan. The enterprise (500) lets the developer (200) or architect, who was proposed the adopted alternative plans, set up the practical design service (A5), and requests the approval for project to a relevant government office.

When the project is approved and the specific floor area ratio is determined, the enterprise (500) can be supported with the construction asset (A2) by making the financial institutions (400) issue the real-right on development securities (M2) within a certain range of the determined floor area ratio (for example, 80%) for the investor (600) to be subscribed.

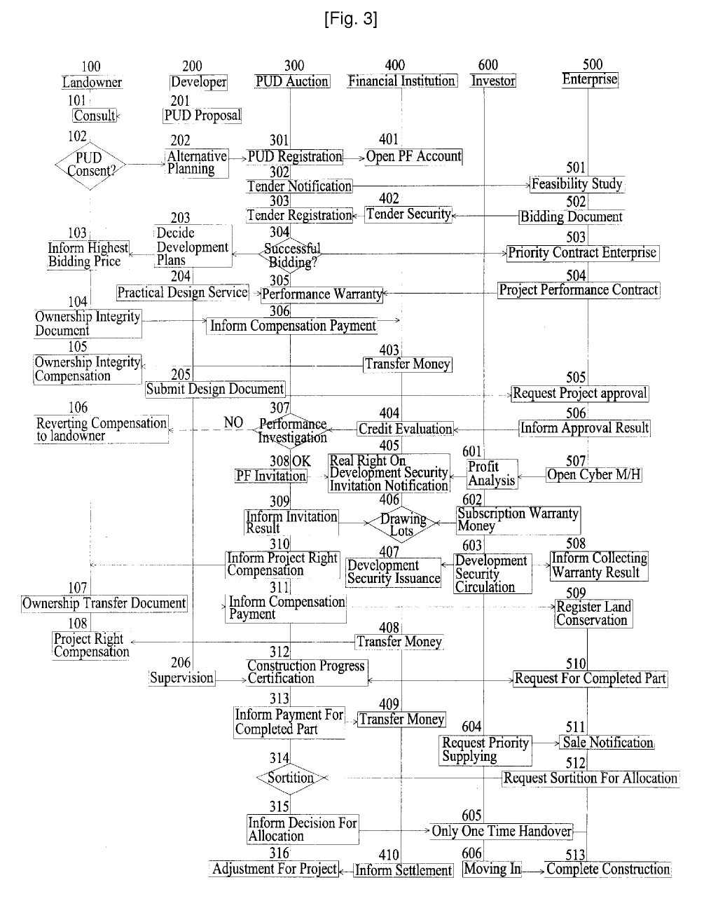

FIG. 3 is the flowchart illustrating all steps from establishment of development district to completion of construction project, in accordance with the present invention.

The FIG. 3 also shows the auction procedure using the PUD auction server through Internet and the procurement procedure for construction asset with construction asset backed securities.

As shown in FIG. 3, the developer (200) provisionally will determine the project area by considering regional conditions and reviewing national & regional comprehensive plans and situation about the subject districts, and obtain a more than 80% of landowner's incorporation consent (102). Then, the graphical and land use information for incorporated lands will be registered, the specific development zoning procedure is proceeded, and the step of proposing the project land (PUD) to be auctioned for the project site into the GIS folder of PUD auction server is followed (301). As similar to the steps illustrated in FIG. 2, the developers (200), the engineering companies and architects, etc. will analyze the location conditions of PUD land, envisage and register (202) the development plan approvable for project by using the Alternative Planning Platform in PUD development folder.

The above Alternative Planning Platform, i.e. the systemized design form reasonably making the development plan proposal based on the related regulations and infrastructure for urban planning, is the platform which is inter-connected with the drawings (CAD and CAM, etc.) for each planned part of plan and the files for analyzing the feasibility of development proposals. The above the drawings for each planned part of plan will include land usage plan, transportation plan, service facility plan, environment management plan, municipal program, etc.

The PUD auction server (300) will search all information that is input by the operator of PUD auction server (300). The above information may include the information about the cost index of development project land, the supply amount and sale ratio of construction assets for each PUD land at the auctioning time, and the demand information about the project lands for each district and purpose which are provisionally requested by the enterprises. The PUD auction server (300) will sort the PUDs to be auctioned and to have a high response PUD in regional market located in the whole country after setting up the multiple development plans (202), and determine the sequences of the PUD to be auctioned in itself. Then, the PUD auction server makes the financial institutions, where issue the securities, open the chosen PUD account (401), and enters into the tender notification (302) on Internet and informs the registered enterprises (500) of the tender information through e-mail.

The enterprises (500), who received the above tender information, review the development proposals which are proposed by the object PUD in the PUD auction server, analyze the project feasibility, confirm the bidding proposal, transfer the tender security (402) into the PF account (401), and complete the registration for tender (303). Then, the password for tender is transferred to the enterprises.

A number of tenders, i.e. candidates for enterprises, who connect the PUD auction's web server (S1) at the date designated on the tender notification, will input password and take step for certification. The bidding table is opened when the bidding page is clicked, the popup windows for confirming the bidding details will be opened when the name, the registration number, the belonged organization and the tender price are input and the bidding key is pressed. When “OK” key is pressed, the relevant information including the bidding time, the bidding order, the name and registration number of bidder and the bidding price will be described in the secured bidding certificate, and sent the above bidding certificate to the bidder's e-mail.

The bidding details registered in the PUD auction server is automatically evaluated without a delay after closing tender by means of the Successful Bidder Determining Program. For example, the lists and details of the tenders from 1st to 10th grades are opened to public. The enterprises (500), whose bidding is accepted, will be automatically informed the bidding result along with the details for contract through email.

Through the Successful Bidder Determining Program, the successful bidder will be determined based on the capability points for carrying out construction (50%) and the bidding price points (50%). In addition, the points for appeasing monopoly (+5%) may be added. Then, the highest scorer will be determined as a priority contract enterprise (503) considering the above various points.

Regarding the capability evaluating items for carrying out the construction when the average constructions records for the nearest three (3) years are higher than the bidding price, the 25 points will be given. However, if the above average records are less than the bidding price, the 15 points will be given. In addition, when the company capital is higher than a half (½) of the bidding price, the 25 points will be given, and the above capital is higher than one third (⅓) but less than a half (½) of the bidding price, the 15 points will be given. When the above capital is less than one third (⅓) of the bidding price, however, the 10 points will be given. The bidding price points of the highest bidder will be the 100 points. The next highest bidder (from 2nd highest bidder to 15th highest bidder) will be given the points decreasing with five (5) points. All bidders below 16th grade will be given with 20 points. When the difference in bidding prices between the highest and the 2nd highest bidder is over 30% or the only one bidder is applied, the above bidding price point will be zero (0). The Successful Bidder Determining Program will save the above results into the Bidding Result File of the DB server (S3).

The enterprise (500), who is successful bidder for PUD auction and informed as a priority contract enterprise (503), submits the obligation and proof documentations (504) to the PUD auction, makes the performance bond (305) for a successful project performance and enters into the contract for undertaking project lands. The enterprise (500) who made a contract for undertaking project lands sends the payment plans to the PUD auction server (300) by e-mail within ten (10) days from the contracting date and enters into the step to pay the money for purchasing land. The above payment plans is the plan to pay the money for purchasing land to the incorporated landowners (100).

The compensation payment for purchasing land (306) is divided into the land ownership integrity compensation (105) and the project right compensation (108). As the safety means to preserve the integrity for the priority to the original acquisition for the project land after the successful bidding date, the above land ownership integrity compensation (105) will be paid to the landowner (100) and the interested party with the declared land price, in order not to occur the disability to the ownership right or pledge right when the enterprise (500), who is successful bidder for the PUD auction, takes over the project land. After the money corresponding to the land ownership integrity compensation (105) is paid, the transfer of ownership, the creation of superficies or the exercise of pledge right is not possible without the consent of enterprise (500).

The project right compensation (108) is paid with an amount of money deducted the contract money from the above land ownership integrity compensation money. When the project land contractor (enterprise) received a project approval from the authorized office, the above project right compensation (108) can be paid with the money supplied by the real-right on development securities (407) which are certificated and issued by the entrusted financial institutions within the certain range (e.g. 80%) of the approved floor area ratio.

The project right compensation money for purchasing land will be sequentially paid from the landowner who submitted all relevant document for transferring the project land and completed the beforehand performance, through on-line. Although the enterprise (500) is obtained the project approval, however, the status of a priority contract enterprise will be deprived, the above status will be transferred to the next highest bidder, and the paid ownership integrity compensation will be reverted to land owner, when it is determined that the possibility of success in issuing the real-right on development security cannot be guaranteed, since the project feasibility is significantly low with the result of the credit evaluation (404) of financial institution (400) and the performance investigation (307) of PUD auction server (300).

The financial institutions, entrusted (308) for issuance of the real-right on development securities from the PUD enterprise (500) having a good evaluation of the project approval, will inform the notification to collect the development security in order to supply the project finance through Internet, and receive the subscriptions when subscription warranty money is transferred to the subject PF account (401). If too many subscriptions to the promising PUD are applied, the computer may decide the winner for bidding. The real-right on development securities will be issued with the face value based on the one (1) share per each square meter (m2) of construction floor for supplying. Taking the construction floor into the consideration, the subscribers and the number of subscription will be determined. The result of issuance of the real-right on development security for each site is saved DB server (S3) of PUD auction system.

The investors (600) may freely circulate the real-right on development securities through the stock markets. When there is a sale notification from the enterprises (500), the above development securities can be transferred into the priority request for supplying and exchanged with the dividend when development projects are settled.

The construction assets of PF account (401), supplied by the issuance of the real-right on development securities, can be drew out only by the request for the completed parts per each step from the enterprises (500). In order to guarantee a successful completion of construction work ensuring a continuous business of PUD auctions, the too many payment for the completed parts should be excluded. In order to increase the project site warranty ratios of the input to the maximum, a supervisor inspect the construction progress certification (312) and the animation documents (S2) checking progress situation for the construction site, and the step of the payment notification for completed part per each step will be proceeded. The 80% of money, drawn out for completed parts, will be directly paid for the input material costs and labor costs.

When the enterprise (500) opens the sale notification (511), the investors having the securities corresponding to the position of construction floors can do a priority candidate request pursuant to the supply regulations. For example, the above investors will receive the same chance with the 1st order subscription depositor, and may hand over one (1) time under the residence conditions.

### INDUSTRIAL APPLICABILITY

As discussed in the above, the present invention can be efficiently utilized for the construction asset backed securities method with PUD auction through Internet. It will be apparent to those skilled in the art that various modifications and variations can be made in the present invention without departing from the spirit or scope of the invention.

1. The construction asset backed securities method through Internet comprising the following steps:
registering developers, enterprise (SPC) and financial institutions accessed to the PUD auction server as main bodies for development project;
proposing the project land for auction received the consents of enrolled landowners within the subject districts, after determining the project boundary with the Optimal Zoning Program in GIS fold of the Geography and Image server (S2) based on the overall data for a group of enrolled lands which are input by registered developer;
registering multiple alternative plans approvable to project as the development proposals for each PUD land of DB server, the above alternative plans are established for the PUD lands which are taken a procedure for determining the specific development district through the Alternative Planning Platform of PUD development folder;
determining the best development plan for each PUD land through the successful bidding, the above bidding is determined by evaluating the points of bidding prices in addition to the points for appeasing monopoly and the points of performance capability of the enterprises through the Successful Bidder Determining Program after receiving the biddings of enterprise about the multiple alternative plans registered for each PUD land through the bidding program of auction folder in the web server (S1); and
circulating the real-right on development securities as construction assets, the above development securities are issued in connection with the financial institutions with certain rate of constructing floor area ratio approved by authorized office under the best development plan.

2. The method according to claim 1, wherein the above step for registering multiple alternative plans as the development proposals for each PUD land of DB server comprises the following steps:
certificating the development proposal planners to confirm whether the above planners are registered in the PUD development folder or not, when the planners are accessed to the PUD auction server through Internet;
confirming and modifying the lists and contents previously submitted by the above planners and the contents of development proposal under working;
planning and modifying the development proposals for each PUD by running the Alternative Planning Platform.

3. The method according to claim 1, wherein the above step for determining the best development plan for each PUD land determines the successful bidder based on the bidding price points (50%) and the capability points for carrying out construction (50%), with the points for appeasing monopoly (±5%) being added into the sum of the above points, wherein the above bidding price points are given the 100 points to the highest bidder and decreased with a certain points from the next highest bidder, the capability points for carrying out development project are evaluated based on the amount of company capital and the average constructions records during the nearest three (3) years, and the above points for appeasing monopoly are calculated with ±5% based on the one (1) time success during one (1) year and total three (3) times successes during three (3) years for the PUD auctions in process.

4. The method according to claim 1, wherein in the above step for circulating the real-right on development securities as construction assets, the enterprises determine the face value of the real-right development securities with the one (1) share per each square meter (m2) of construction floor area for supplying, receive the subscriptions and issue the real-right development securities in connection with the financial institutions without the collaterals through on-line within a certain range (80%) of the constructing floor area ratio approved by the authorized office, and thereby supply the initial construction assets.
